(19) United States
(12) Patent Application Publication
(10) Pub. No.: US 2008/0164630 A1
(43) Pub. Date: Jul. 10, 2008

(54) Laminating Apparatus For Tti-Labels Combined With Cutting And Applying The Same

(76) Inventor: Uri Freiman, Haifa (IL)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 11/816,126

(22) PCT Filed: Feb. 9, 2006
(86) PCT No.: PCT/IL06/00167

§ 371 Date: Aug. 13, 2007

Related U.S. Application Data
(60) Provisional application No. 60/652,350, filed on Feb. 11, 2005.

(51) Int. Cl. B28B 11/14; B29C 43/30

(52) U.S. Cl. 264/145; 425/328

(57) ABSTRACT

The disclosed invention provides a combined laminating, cutting and applying apparatus and method to manufacture time temperature indicator (TTI) labels for sensitive commodity items, wherein a chemical reaction occurs within the labels. The combined apparatus comprises a plurality of rollers withdrawing layers with chemicals that are being brought in contact by a presser. When the reactants are being pressed together, a temperature or time or both sensitive reaction starts between the layers. The label is being cut and immediately adhered on a commodity item that is also sensitive to time/temperature parameters so as to visually indicate the conditions to which the label had been exposed.

### FIELD OF THE INVENTION

The present invention relates to TTI label production and dispensing. More particularly, the present invention relates to laminating apparatus for labels that is combined with cutting the labels and applying them onto a product.

### BACKGROUND OF THE INVENTION

There are consumable products that undergo biological or chemical processes during storage. Those products are mainly sensitive to time and/or temperature. Time and temperature indicator (TTI) stickers are developed in the chemistry field in order to avoid waste of such products and to alarm customers from a spoiled product. The TTI indicators incorporate reactants that are also time and temperature dependent and are provided with a visible mechanism that indicates the state of the indicator as for exposure to time or to temperature or both. The indicators are attached to the product. The stickers with the indicators are adapted to indicate the condition in which the product is maintained.

One of the problems and limitations of the TTI labels and one of the reasons they are not extensively in use is that the reactants have to be brought into close contact to each another in a certain point of time and preferably before they are shifted from the plant to the store or immediately after they are being brought to the temperature conditions in which they should be stored. In most cases, the stickers or labels are provided with at least two layers that have to be laminated together in order to start the reaction of the reactant provided on the layers. Only when the layers are laminated together, the indicatory reaction starts.

Manufacturing of labels is known in the art. There are apparatii for printing information, cutting the labels and for applying them on the articles. An example for cutting and applying labels is disclosed by Strohmeyer et al. in U.S. Pat. No. 6,164,356 “Low pressure actuates labeling apparatus” filed in 1998. In this patent, the printing unit is printing the information on a label; the label is drawn from a roll of continuous label stock. A cutting unit cuts a printed label from an end of the roll with the cut label being deposited on a tamper unit which transports the label to a position adjacent the article and affixes the label to the article. Cutting apparatus is disclosed in U.S. Pat. No. 6,772,663 “apparatus and method for rotary pressure cutting” by Machamer in 2002. This improved rotary pressure cutting apparatus cuts, perforates, and scores plies of paper, window materials, label stock, and plastic laminates in conjunction with soft, discontinuous, and/or non-cylindrical anvil surfaces. The sticking process was also addressed and is disclosed in JP4,128,121 “device for sticking labels” by Seisaku. In this patent, a heat adhesive label is held by a reel and transferred by a transferring means to a cutting means and then to a heat pressing means where it is attached to a postcard.

Other devices that are patented or available in the industry addresses other specific needs; however, there is no available apparatus that addresses the problems and needs of manufacturing a TTI label and applying it onto the product prior to its transfer to the consumer or stored in the conditions in which it is maintained.

### SUMMARY OF THE INVENTION

It is an object of the present invention to provide an apparatus that laminates two layers together wherein each layer is provided with a certain reactant in order to establish a TTI label, cutting the label and dispensing it onto the products of which condition is to be monitored. As soon as the two reactants are in contact, the reaction that visibly indicates the time or temperature to which the label was exposed to starts.

It is another object of the present invention to provide an apparatus that is simple to operate and can be easily incorporated in a conveyor belt that conveys the product onto which the label is to be applied.

It is yet another object of the present invention to provide a method of laminating, cutting and applying a TTI label.

It is therefore provided in accordance with a preferred embodiment of the present invention, a combined laminating, cutting and applying apparatus adapted to manufacture time temperature indicator (TTI) labels for sensitive commodity items, wherein a chemical reaction occurs within the labels, the combined apparatus comprising:
a first roller adapted to provide a self adhering base layer, wherein said base layer is provided with a first chemical reactant;
a second roller adapted to provide a lamination layer, wherein said lamination layer is provided with a second chemical reactant;
a presser adapted to receive said base layer and adjacently attached said lamination layer and press the layers together so as to establish good contact between said first reactant and said second reactant and to allow the to react between said base layer and said lamination layer;
a cutting mold adapted to cut a plurality of predetermined shaped labels from adjacently attached layers;
a dispenser adapted to adhere said plurality of predetermined shaped labels onto the commodity item.

Furthermore and in accordance with another preferred embodiment of the present invention, said presser comprises a top cylinder pressed onto a bottom cylinder.

Furthermore and in accordance with another preferred embodiment of the present invention, said cutting mold is a top mold cylinder.

Furthermore and in accordance with another preferred embodiment of the present invention, the apparatus further comprises at least one roller adapted to receive unnecessary portions of said base layer and of said lamination layer.

Furthermore and in accordance with another preferred embodiment of the present invention, said plurality of labels is adhered onto the commodity items that are forwarded onto a conveyor belt.

Furthermore and in accordance with another preferred embodiment of the present invention, it is provided a method for laminating, cutting and applying TTI labels on commodity items comprising:
withdrawing a self adhering base layer of a first roller, wherein said base layer is provided with a first chemical reactant;
withdrawing a lamination layer of a second roller, wherein said lamination layer is provided with a second chemical reactant;
attaching said laminating layer onto said base layer wherein said first reactant faces said second reactant;
pressing said base layer onto said lamination layer so as to establish good contact between said first reactant and said second reactant;
cutting plurality of predetermined shaped labels from the adjacently attached layers;
applying said plurality of predetermined shaped labels onto the commodity items.

In addition and in accordance with yet another preferred embodiment of the present invention, the method further comprising eliminating unnecessary portions of the layers.

### BRIEF DESCRIPTION OF THE FIGURES

In order to better understand the present invention and appreciate its practical applications, the following Figures are attached and referenced herein. Like components are denoted by like reference numerals.

It should be noted that the figures are given as examples and preferred embodiments only and in no way limit the scope of the present invention as defined in the appending Description and Claims.

FIG. 1 illustrates a laminating apparatus combined with cutting and applying TTI labels in accordance with a preferred embodiment of the present invention.

FIG. 2 schematically illustrates an upper view of the apparatus for producing TTI labels shown in FIG. 1 showing the steps of manufacturing the labels in accordance with a preferred embodiment of the present invention.

### DETAILED DESCRIPTION OF THE INVENTION AND FIGURES

The present invention provides a unique and novel apparatus for manufacturing labels that are provided with chemical materials. The final label should be comprised of two adjacently attached layers wherein each layer is provided with a reactant. Upon contacting both layers together, a reaction starts that specifically indicates time or temperature or both parameters to which the label was exposed to. Before lamination, each layer that produces the label carries at least one chemical reactant that is not active. The chemical materials are due to start reacting when the labels, which are produced from at least two layers, are laminated. According to one aspect of the present invention, an apparatus is provided that is adapted to produce the labels from the adjacent attached layers while causing a reaction when the layers are laminated together.

Since a TTI label is adapted to be adhered to the product immediately after or while the reaction is started, it is important that the apparatus will be incorporated with a conveyer belt carrying the product before it is being shifted to the consumer. It is important to realize that such a TTI label cannot be prepared in advance and be adhered onto the product after some time.

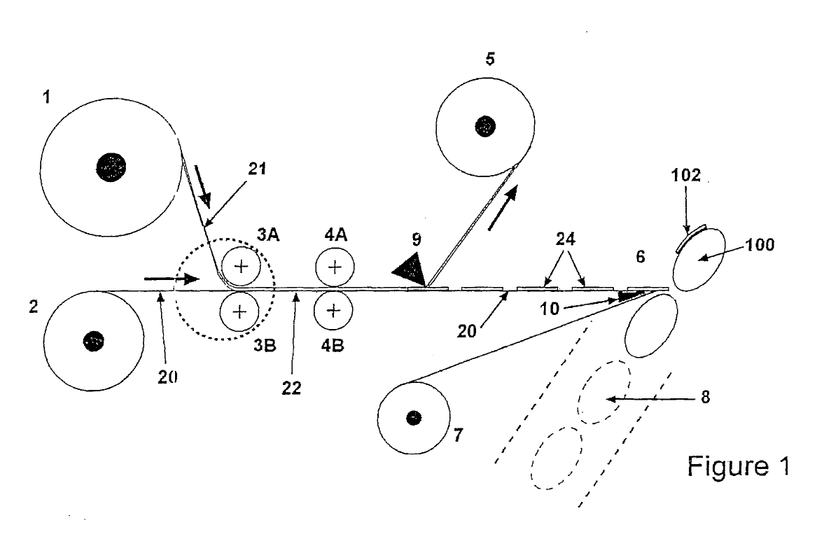

Reference is now made to FIG. 1 illustrating a laminating apparatus combined with cutting and applying TTI labels in accordance with a preferred embodiment of the present invention. At least two rollers are provided and in particular, a first roller 2 is provided with the self adhesive material that may comprise, for example, a layer of paper onto which at least one layer of chemical reactant is provided. This layer is a self adhesive base layer as known in the art that may comprise silicone paper onto which a paper layer is adhered. The chemicals are spread onto the paper layer. Base layer is preferably positioned over a bed (not shown in the figures). A second roller 1 is provided with a laminating material such as polypropylene. The sheet of laminating material is provided with at least one chemical material that is preferably spread on it. It is optional to provide any number of rollers that corresponds the number of layers that are needed for the final product that is the label.

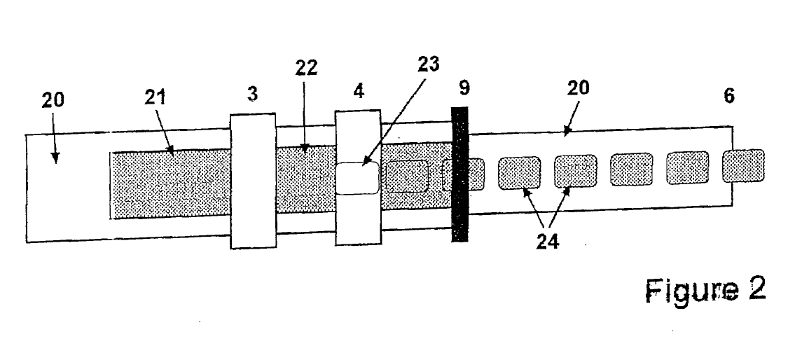

Reference is now made also to FIG. 2 illustrates an upper view of the apparatus for producing TTI labels shown in FIG. 1 showing the steps of manufacturing the labels in accordance with a preferred embodiment of the present invention. Base layer 20 that is rolled of first roller 2 (shown in FIG. 1) is shown from an elevated view. Laminating layer 21 is withdrawn of second roller 1 that is shown in FIG. 1 and is being placed on base layer 20. It should be emphasized that base layer 20 is placed with the chemical reactant on top of the layer while laminating layer 21 is placed on top of base layer 20 while the chemical reactant is facing the base layer.

Both layers, base layer 20 and lamination layer 21 are fed in between a top cylinder 3A and a bottom cylinder 3B in order to press both layers together and establish good contact between the reactant of the two layers and start the reaction. In this instant, the chemical reactants from both layers are in contact and a reaction between the reactants starts. It should be noted that the presser can be any other presser rather than cylinders 3A and 3B that is adapted to press both layers together. For example, the presser can be produced of plates that are being pressed together when both layers are adjacent attached to one another.

Combined sheet 22 is forwarded to be inserted in between bottom cylinder 4B and upper cylinder 4A wherein upper cylinder 4A is provided with a mold that cuts a shape of a label 23 of combined sheet 22. It should be noted that any other mold shaper can be used in order to cut the stickers to a predetermined shape. Upper cylinder 4A solely forms a cut in the shape of the mold (the mold cannot be seen in the Figures) in the upper layer of the sheet, which is laminating layer 21.

Combined sheet 22 is forwarded to an eliminator 9 that eliminates the unnecessary portions of the laminating layer that are being collected in a collecting roller 5. After eliminator 9, TTI labels 24 are being left on base layer 20.

Labels 24 are adapted to be adhered onto commodity items. Commodity items 8 are arranged on a moving conveyor belt that is represented in FIG. 1 by doted lines. The conveyor belt can be any conveyor that is known in the art. Each commodity item is moved to point 6 where the portion of base layer 20 that comprises the silicone paper is being removed by a dispenser 10 that shifts the silicone paper to a roller 7 while leaving labels 24 to be adhered onto commodity item 8. A commodity item 100 that is being moved adjacent to point 6 is being adhered with a label 102.

At that point of time, the reactants between the base layer and the laminating layer that forms the label are already reacting and visually indicates that exposure of the label to time or temperature. As an example, the reactants could be such that changes their color when exposed to relatively high temperature levels such as room temperature. Labels that comprise such reactants are suited for commodities that should be transferred and stored in low temperature conditions such as diary products. The labels should be adhered onto the product immediately after production and before they are being delivered. Therefore, cannot be pre-prepared and maintained in room temperature. Similarly, there are products in which the time of exposure to relatively high temperature is critical. Therefore, the reactants that are being provided between the layers are sensitive to time and temperature. Many combinations of reactants and contact points can be designed in order to manufacture a TTI label that suits a predetermined condition.

It should be clear that the description of the embodiments and attached Figures set forth in this specification serves only for a better understanding of the invention, without limiting its scope as covered by the following Claims.

It should also be clear that a person skilled in the art, after reading the present specification can make adjustments or amendments to the attached Figures and above described embodiments that would still be covered by the following claims.

1. A combined laminating, cutting and applying apparatus adapted to manufacture time temperature indicator (TTI) labels for sensitive commodity items, wherein a chemical reaction occurs within the labels, the combined apparatus comprising:
a first roller adapted to provide a self adhering base layer, wherein said base layer is provided with a first chemical reactant;
a second roller adapted to provide a lamination layer, wherein said lamination layer is provided with a second chemical reactant;
a presser adapted to receive said base layer and adjacently attached said lamination layer and press the layers together so as to establish good contact between said first reactant and said second reactant and to allow the to react between said base layer and said lamination layer;
a cutting mold adapted to cut a plurality of predetermined shaped labels from adjacently attached layers;
a dispenser adapted to adhere said plurality of predetermined shaped labels onto the commodity item.

2. The apparatus as claimed in claim 1, wherein said presser comprises a top cylinder pressed onto a bottom cylinder.

3. The apparatus as claimed in claim 1, wherein said cutting mold is a top mold cylinder.

4. The apparatus as claimed in claim 1, wherein the apparatus further comprises at least one roller adapted to receive unnecessary portions of said base layer.

5. The apparatus as claimed in claim 1, wherein the apparatus further comprises at least one roller adapted to receive unnecessary portions of said lamination layer.

6. The apparatus as claimed in claim 1, wherein said plurality of labels is adhered onto the commodity items that are forwarded onto a conveyor belt.

7. A method for laminating, cutting and applying TTI labels on commodity items comprising:
withdrawing a self adhering base layer of a first roller, wherein said base layer is provided with a first chemical reactant;
withdrawing a lamination layer of a second roller, wherein said lamination layer is provided with a second chemical reactant;
attaching said laminating layer onto said base layer wherein said first reactant faces said second reactant;
pressing said base layer onto said lamination layer so as to establish good contact between said first reactant and said second reactant;
cutting plurality of predetermined shaped labels from the adjacently attached layers;
applying said plurality of predetermined shaped labels onto the commodity items.

8. The method as claimed in claim 7, further comprising eliminating unnecessary portions of the layers.

9. A combined laminating, cutting and applying apparatus adapted to manufacture time temperature indicator (TTI) labels for sensitive commodity items, wherein a chemical reaction occurs within the labels, the combined apparatus, substantially as described in the above specification, attached Figures and appending claims.

10. A method for laminating, cutting and applying TTI labels on commodity items substantially as described in the above specification, attached Figures and appending claims.
